(19) United States
(12) Patent Application Publication
(10) Pub. No.: US 2018/0191811 A1
(43) Pub. Date: Jul. 5, 2018

(54) DISTRIBUTED SERVER SYSTEMS AND DATA PROCESSING METHODS

(71) Applicant: UBTECH Robotics Corp., Shenzhen (CN)

(72) Inventors: Youjun Xiong, Shenzhen (CN); Xiaolai Dai, Shenzhen (CN); Desen Su, Shenzhen (CN)

(21) Appl. No.: 15/603,466

(22) Filed: May 24, 2017

(30) Foreign Application Priority Data
Dec. 31, 2016 (CN) 201611266116.5

(51) Int. Cl. H04L 29/08; G06F 17/30

(52) U.S. Cl. CPC H04L 67/1002; G06F 17/30377; G06F 17/30867; H04L 67/02

(57) ABSTRACT

The present disclosure relates to a distributed server system includes: a load balance server to be as a front server of a plurality of WEB servers, wherein load balance server is configured to receive to user request, to poll the WEB servers in sequence, and to transfer the user request to the WEB servers, the WEB servers connecting with the load balance server. The WEB server is configured to receive the user request, to perform a data processing process according to a variety of the user requests, and to conduct a read-write operation process with respect to at least one database, the database connecting with the WEB servers. The database is configured to add, delete, correct, and query data according to the user requests.

### CROSS REFERENCE TO RELATED APPLICATIONS

This application claims priority to Chinese Patent Application No. 201611266116.5, filed Dec. 31, 2016, which is hereby incorporated by reference herein in its entirety.

### BACKGROUND

### 1. Technical Field

The present disclosure relates to World Wide Web (WEB) uniform resource locator (URL) field, and particularly to a distributed server system and a data processing method.

### 2. Description of Related Art

With the progress of the internet, particularly to social network, internet of things (IOT), cloud computing, a variety of sensors have been wildly adopted. A variety of unstructured data, characterized by huge volume and great timeliness ability, has emerged. As such, the concept of big data is generated. The big data is characterized as follow: 1. Huge data volume. All data is stored, and the data is calculated by pebibyte (PB). 2. Great varieties of data types. The data types of the big data are not limited to the present disclosure. They are much more about pictures, videos, audios, geographic position information, and the like. Personalized data is an absolute majority. 3. Processing speed is fast. The data is obtained within seconds. 4. Low value density. Usually, the valuable data is merely a few kilobytes (KB) among terabytes (TB) of data.

How to obtain, gather, and analyze the big data has become a significant issue. In the conventional application (APP) environment, user behavior record has become more and more important. Currently, there are a plurality of ways to preserve the user behavior data in the database, wherein the user behavior data mainly includes page view (PV), unique visitor (UV), internet protocol (IP), and the detailed action instructions of users. In order to analyze the big data, the user behavior and images are presented to provide the bases of accurate data. As such, the operators may accurately evaluate the real user.

However, millions, tens of millions, or even billions of PV generated everyday may cause a high loading to the database and also the information preserved in the database is too unitary, which may lead to a great influence on the system stability and scalability. Moreover, the preserved data may not be queried and updated regularly. Therefore, a simple and useful structure and database is adopted to store the great amount of data, and to query the content immediately.

### BRIEF DESCRIPTION OF THE DRAWINGS

FIG. 1 is a flow chart of a data processing method of distributed servers in accordance with one embodiment of present disclosure.

FIG. 2 is a flowchart of a data processing method of distributed servers with data having an access volume greater than a predetermined access volume in accordance with one embodiment of present disclosure.

FIG. 3 is a schematic view of a distributed server in accordance with one embodiment of present disclosure.

FIG. 4 is a schematic view of application modules operating within a WEB server.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown. The figure and the embodiment described according to figure are only for illustration, and the present disclosure is not limited to these embodiments.

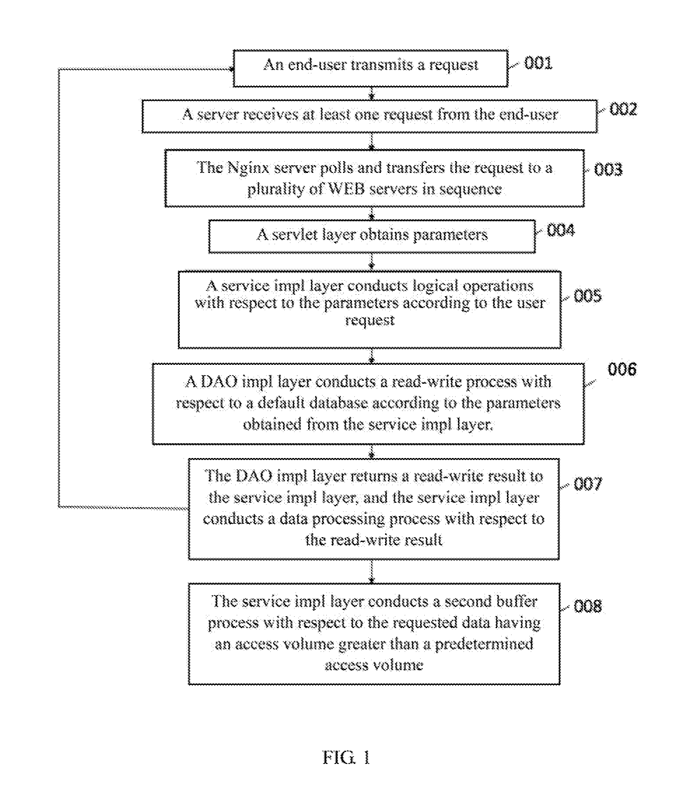

In one embodiment, the present disclosure provides a data processing method of distributed servers as shown in FIG. 1. The method includes:

In Step 001: an end-user transmits a request.

The end-user transmits the request via entering URL on a browser or conducting an operation on WEB pages, such as to enter to other pages, to login, to query, and the like.

In Step 002: a server receives at least one request from the end-user.

The end-user transmits the request to the Nginx server, and the Nginx server conducts a first buffer process in sequence. In one example, the server maybe the Nginx server. In another example, the server may be load balance servers capable of polling and transferring.

In Step 003: The Nginx server polls and transfers the request to a plurality of WEB servers in sequence.

The Nginx server operates as a reverse proxy and polls the WEB servers in sequence, so as to balance the load. The Nginx server transfers buffered requests to the WEB servers in sequence, such that the number of the requests of the WEB servers may be balanced. For example, the number of the requests is 30, and the number of the WEB servers is 3. The Nginx server transfers a first buffer request to a first WEB server, transfers a second buffer request to a second WEB server, transfers a third buffer request to a third WEB server, transfers a fourth buffer request to the first WEB server, and the like.

In Step 004: a servlet layer obtains parameters.

In an example, the parameters may include username, passwords, and the like. The servlet layer is one of application modules operating within the WEB servers. The servlet layer responses to the request transferred from the Nginx server, and the servlet layer analyzes the request to identify and obtain at least one corresponding parameter.

In Step 005: a service implementation (service impl) layer conducts logical operations with respect to the parameters according to the user request.

The service impl layer is one of the application modules operating on the WEB servers. The service impl layer conducts an inspection process with respect to the parameters obtained from the servlet layer to confirm whether a data format and a data type are correct. The service impl layer conducts the logical operations according to the user request. In an example, the logical operations may relate to query, store, delete, and so on.

In Step 006: a data access object implementation (DAO impl) layer conducts a read-write process with respect to a default database according to the parameters obtained from the service impl layer.

The DAO impl layer is one of the application modules operating on the WEB servers. The DAO impl layer conducts the read-write process with respect to the default database according to the parameters obtained from the service impl layer. The parameters is distributed to different databases within a database server according to their sorts, such as log data and behavior record data are distributed to a Mongo database, other information except the log data and the behavior record data is distributed to a mini structured query language (MySQL) reading database and a MySQL writing database. As such, the MySQL and the Mongo database are operated in parallel, which contributes to the convenience of data maintenance and data access. Due to the Mongo database is stored with text files and the Mongo database is of non-relational type having a buffer mechanism and is capable of data partition, the Mongo database may query data within the Mongo database via a SQL index. The read-write process includes an add process, a delete process, a correct process, and a query process. The add process relates to store the MODE to the database server. The delete process and the query process relate to query the databases server so as to determine whether there is any data matches the user request according to an identifier (ID) of the MODE or other factors. The process may go to the read process or the delete process upon determine the data matching the user request exists in the database.

In Step 007: the DAO impl layer returns a read-write result to the service impl layer, and the service impl layer conducts a data processing process with respect to the read-write result.

After the read-write process, the DAO impl layer returns the read-write result to the service impl layer, wherein the read-write result indicates whether the parameters have been successfully written into the database server or the data has been queried. The service impl layer conducts the data processing process with respect to the read-write result according to a variety of the user requests, and returns the read-write result to the end-user.

In Step 008: the service impl layer conducts a second buffer process with respect to the parameters having an access volume greater than a predetermined access volume.

The service impl layer determines whether the parameters have been frequently accessed or basic data, such as background information on the web page, having the access volume greater than the predetermined access volume according to the read-write result. If the parameters are the frequently accessed data or the basic data having the access volume greater than the predetermined access volume, the service impl layer conducts the second buffer process with respect to the parameters.

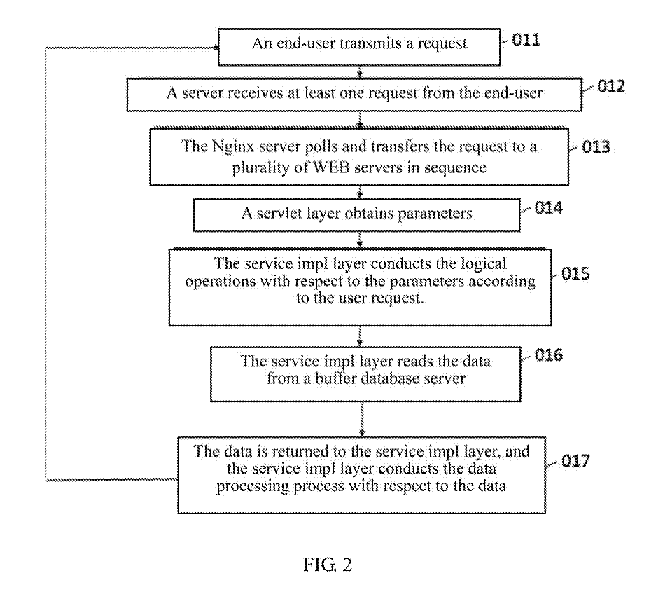

FIG. 2 is a flowchart of a data processing method of distributed servers with data having the access volume greater than the predetermined access volume. The processing steps include:

In Step 011: the end-user transmits the request.

The end-user transmits the request via entering URL on the browser or conducting the operation on WEB pages, such as to enter to other pages, to login, to query, and the like.

In Step 012: the server receives the request from the end-user.

The end-user transmits the request to the Nginx server, and the Nginx server conducts the first buffer process in sequence. In one example, the server may be the Nginx server. In another example, the server may be load balance servers capable of polling and transferring.

In Step 013: The Nginx server polls and transfers the request to WEB servers in sequence.

The Nginx server operates as the reverse proxy and polls the WEB servers in sequence, so as to balance the load. The Nginx server transfers buffered requests to the WEB servers in sequence, such that the number of the requests of the WEB servers may be balanced. For example, the number of the requests is 30, and the number of the WEB servers is 3. The Nginx server transfers the first buffer request to the first WEB server, transfers the second buffer request to the second WEB server, transfers the third buffer request to the third WEB server, transfers the fourth buffer request to the first WEB server, and the like.

In Step 014: the servlet layer obtains parameters.

The servlet layer is one of application modules operating on the WEB servers. The servlet layer responses to the request transferred from the Nginx server, and the servlet layer accesses and analyzes the request to obtain the parameters.

In Step 015: the service impl layer conducts the logical operations with respect to the parameters according to the user request.

The service impl layer is one of the application modules operating on the WEB servers. The service impl layer conducts the inspection process with respect to the parameters obtained from the servlet layer to confirm whether the data format and the data type are correct. The service impl layer conducts the logical operations according to the user request. Specifically, the logical operations are to conduct the corresponding MODE assembly.

In Step 016: the service impl layer reads the data from a buffer database server.

Upon the service impl layer determines the parameters have been conducted by the buffer process, the service impl layer reads the data directly from the buffer database server.

In Step 017: the data is returned to the service impl layer, and the service impl layer conducts the data processing process with respect to the data.

The service impl layer conducts the data processing process with respect to the data returned from the buffer database server.

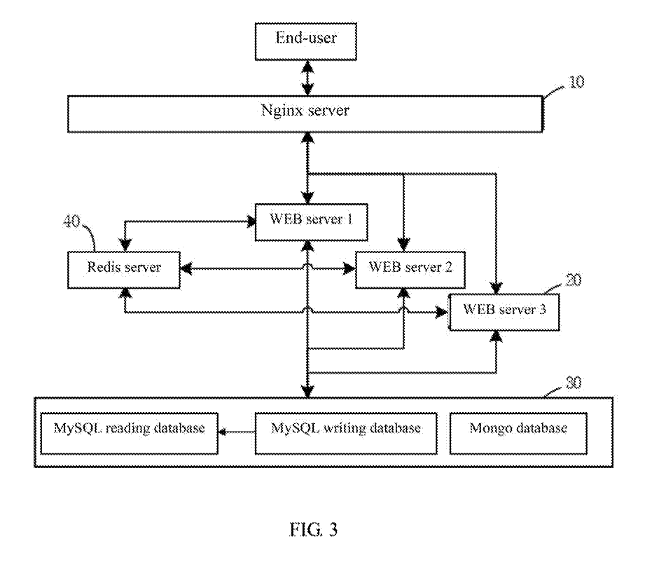

In another embodiment, the present disclosure provides a distributed server system. As shown in FIG. 3, the distributed server system includes the server 10 as the front server of the WEB servers, wherein the Nginx server 10 is configured to poll and transfer the user request to the three WEB servers, so as to balance the load of the three WEB servers. In one example, the front server may be the Nginx server. In another example, the front server may be servers capable of balance the load.

The distributed server system further includes three WEB servers 20 connecting with the Nginx server 10, wherein the WEB servers 20 is configured to receive the user request transferred from the Nginx server 10, to conduct the data processing process according to a variety of the user request, and to conduct the read-write operation process with respect to the database server.

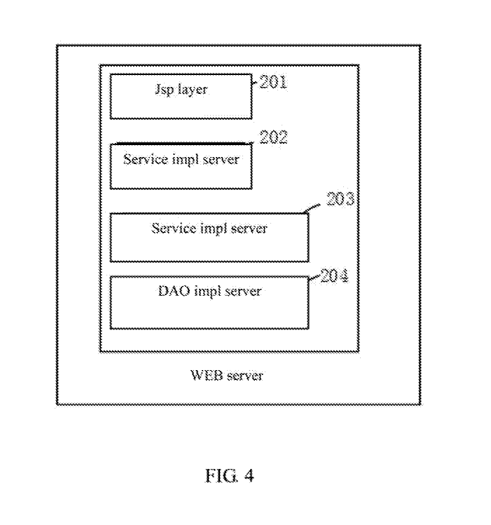

Each of the WEB servers includes application modules operating within. The application modules include: a java server page (JSP) layer 201, the servlet layer 202, the service impl layer 203, and the DAO impl layer 204. As shown in FIG. 4, the JSP layer is a fixed template page that has been successfully posted. The end-user may conduct operations within the JSP layer and submits request. The servlet layer is configured to obtain the parameters, wherein the servlet layer analyzes the request to obtain the parameters. The service impl layer is configured to conduct the data processing process, wherein the service impl layer conducts the logical operations with respect to the parameters according to a variety of user request. The DAO impl layer is configured conduct a data operation process, wherein the DAO impl layer conducts the add process, the delete process, the correct process, and the query process with respect to the corresponding database according to the parameters that has been conducted by the logical operations.

A database server 30 connecting with WEB servers, wherein the database server 30 is configured to add, delete, correct, and query the data requested by the end-user. The database server includes the MySQL database and the Mongo database, wherein the MySQL database may be divided into the MySQL reading database and the MySQL writing database.

The distributed server system further includes the buffer database. In one example, the buffer database may be a Redis database 40 which is configured to store the data having an access volume greater than the predetermined access volume or the basic data having great amount of volume.

The distributed server system and the data processing method of distributed server systems are two aspects based on a same conception. The detail of the method has been fully described, so that the person skilled in the art may understand the structure of device and process of the method in the present disclosure. In order to simplify the description, the detail may not be repeated again.

The specific equipment of an experiment test between two distributed servers, one is the distributed server with the Mongo database and the other one is the distributed server without the Mongo database, is deployed as follow:

Test 1: the distributed server without the Mongo database includes one Nginx server, three WEB servers, and one MySQL database.

Test 2: the distributed server with the Mongo database includes one Nginx server, three WEB servers, one MySQL database, and the Mongo database.

The test results are shown in tables as below:

Test 1:

TABLE 1

| | | The number | Average | |
|---|---|---|---|---|
| Total | | of requests | request | CPU |
| number of | Number | per second | waiting | occupancy |
| requests | of users | (#/sec) | time (ms) | rate |
| 1500 | 50 | 45.16 | 1107.163 | 35% |
| 1500 | 100 | 49.64 | 2014.515 | 50% |
| 1500 | 200 | 47.2 | 4237.442 | 65% |
| 1500 | 300 | 47.44 | 6324.362 | 77% |
| 1500 | 400 | 47.39 | 8441.283 | 77% |
| 1500 | 500 | 47.73 | 10554.63 | 77% |
| 1500 | 600 | 47.88 | | |

Test 2:

TABLE 2

| | | The number | Average | |
|---|---|---|---|---|
| Total | | of requests | request | CPU |
| number of | Number | per second | waiting | occupancy |
| requests | of users | (#/sec) | time (ms) | rate |
| 1500 | 50 | 78.16 | 607.128 | 35% |
| 1500 | 100 | 109.01 | 1414.219 | 41% |
| 1500 | 200 | 125.2 | 2137.442 | 51% |
| 1500 | 300 | 160.44 | 3024.162 | 62% |
| 1500 | 400 | 207.39 | 4041.283 | 69% |
| 1500 | 500 | 249.73 | 6554.63 | 71% |
| 1500 | 600 | 356.18 | 8632.512 | 72% |

In test 1, the data is stored in the MySQL database. When user number is over 300, and the users continuously transmit the requests. The CUP occupancy rate of the MySQL database maintains the same. That is, input/output (IO) of the system has been to a bottleneck, and subsequent requests occupy the connection pool and need wait in sequence. Therefore, the processing speed is slow and more resources are occupied.

In test 2, the data is stored in the Mongo database. The requests processing speed is much faster than stored in the MySQL database, especially when the amount of data increases. For example, when the user number reaches 600, the processing speed of the Mongo database is five times faster than the MySQL, database. Much more amount of data may be processed when the Mongo database and the MySQL database operate in parallel. Moreover. There is no bottleneck in test 2. When the user number reaches 600, the distributed server with the Mongo database may still process great amount of data, and the CPU resources are just in a slow upward trend. The MySQL database is configured to process important data, and the Mongo database is configured to collect and store the data. As such the parallel decompression system may greatly enhance the performance.

The above description is only the embodiments in the present disclosure, the claim is not limited to the description thereby. The equivalent structure or changing of the process of the content of the description and the figures, or to implement to other technical field directly or indirectly should be included in the claim.

What is claimed is:

1. A distributed server system, comprising:
a load balance server configured to receive user requests, to poll a plurality of World Wide Web (WEB) servers in sequence, and to transfer the user requests to the corresponding WEB server;
the WEB servers connecting with the load balance server, wherein the WEB server is configured to receive the user requests transferred from the load balance server, to perform a data processing process according to a variety of the user requests, and to conduct a read-write operation process with respect to at least one database;
the database connecting with the WEB servers, wherein the database is configured to add, delete, correct, and query data according to the user requests.

2. The distributed server system according to claim 1, wherein the distributed server system further comprises a buffer database connecting with the WEB servers, and the buffer database is configured to store the data having an access volume greater than a predetermined access volume.

3. The distributed server system according to claim 1, wherein applications operating within the WEB server comprises: a java server page (JSP) layer, a servlet layer, a service implementation (service impl) layer, and a data access object implementation (DAO impl) layer.

4. The distributed server system according to claim 1, wherein the database comprises a mini structured query language (MySQL) reading database, a MySQL writing database, and a Mongo database.

5. The distributed server system according to claim 4, wherein the Mongo database is configured to store log data and behavior record data, and the MySQL reading database and the MySQL writing database are configured to store data except the log data and the behavior record data.

6. A data processing method of distributed server systems, comprising:
receiving requests from an end-user by a load balance server;
polling a plurality of WEB servers in sequence;
transferring user requests to the corresponding WEB server, wherein the applications operating within the WEB server comprises: a JSP layer, a servlet layer, a service impl layer, and a DAO impl layer;
performing a data processing process via the service impl layer with respect to parameters;
conducting a read-write process with respect to at least one database by the DAO impl layer, wherein the database is adjacent to the other database corresponding to the parameters that has been operated via the service impl layer;
returning the read-write result to the service impl layer to perform the data processing process;
returning the data that has been operated to the end-user.

7. The data processing method of distributed server systems according to claim 6, wherein the data processing process with respect to the parameters comprises:
verifying the obtained parameters, and conducting a logical operations with respect to the verified request data by logic.

8. The data processing method of distributed server systems according to claim 6, wherein the database comprises a Mongo database, a MySQL reading database, and a MySQL writing database.

9. The data processing method of distributed server systems according to claim 8, wherein the conducting process further comprises:
conducting the read-write process with respect to log data and behavior record data via the Mongo database;
conducting the read process with respect to other information via the MySQL reading database;
and conducting the write process with respect to other information via the MySQL writing database.

10. The data processing method of distributed server systems according to claim 6, wherein the process of returning the read-write result further comprises:
conducting a buffer store process with respect to the data having an access volume greater than a predetermined access volume.
